(19) United States
(12) Patent Application Publication
(10) Pub. No.: US 2013/0346253 A1
(43) Pub. Date: Dec. 26, 2013

(54) SYSTEMS AND METHODS FOR ONLINE SHOPPING WITH TRY-BEFORE-YOU-BUY OPTION

(71) Applicant: Cocobop, Inc., Redwood City, CA (US)

(72) Inventors: Kirk Gustafson, Redwood City, CA (US); Marcus Greinke, San Carlos, CA (US)

(21) Appl. No.: 13/922,878

(22) Filed: Jun. 20, 2013

Related U.S. Application Data
(60) Provisional application No. 61/662,015, filed on Jun. 20, 2012.

(51) Int. Cl. G06Q 30/04

(52) U.S. Cl. CPC G06Q 30/04
USPC 705/26.81

(57) ABSTRACT

Systems and methods for online shopping with try-before-you-buy options are disclosed for improving the process of purchasing personal goods over a communications network such as the Internet. A shopper can choose to order an item from a merchant's online system on a trial basis. After the trial period, the shopper can either return the item to the merchant or keep the item. The merchant may only charge the shopper if the shopper decides to keep the item after the expiry of the trial period.

### CROSS-REFERENCE TO RELATED APPLICATIONS

This application claims the benefit of U.S. Provisional Patent Application Ser. No. 61/662,015, filed Jun. 20, 2012, the disclosure of which is incorporated by reference herein in its entirety.

### BACKGROUND OF THE DISCLOSURE

Online shopping is steadily becoming more prevalent. An ever-increasing percentage of the population is relying on Electronic Commerce, or “e-commerce,” to fulfill their shopping needs. However, despite the explosive growth of e-commerce, online sales of goods such as apparel, jewelry, and fashion accessories continue to lag behind other types of goods, such as software, electronic items, and travel packages. This imbalance may be the result of differences in the characteristics of the various offerings.

While shopping for personal items, such as garments, makeup, and jewelry, people often want to touch, try, or otherwise personally evaluate the items before buying them. In traditional stores, for example, a person shopping for a jacket can try the garment on in a dressing room to determine whether it fits well and looks good. If the shopper is satisfied, he/she can then decide to buy the jacket.

Further, traditional stores allow shoppers to enjoy the social components of shopping. For example, people often shop with friends and relatives who may help them decide what to buy and otherwise enhance the shopping experience.

Known e-commerce models allow shoppers to try on an item virtually before buying the item in an attempt to simulate the traditional shopping experience. For example, while shopping for apparel, a virtual model of the shopper may be simulated through photographs, 3-D renderings, or any other suitable methods. An image of apparel may then be placed or superimposed on this virtual model, thereby allowing the shopper to visualize himself/herself wearing the apparel. Such methods often disappoint shoppers for a number of reasons such as inaccurate modeling of the shopper and unrealistic representation of the surroundings, for example. Also, such methods do not allow the shopper to touch and feel the product they are interested in or to participate in a social shopping experience.

### SUMMARY OF THE DISCLOSURE

The above deficiencies and other problems associated with online shopping are reduced or eliminated by the disclosed systems and methods for online shopping with a try-before-you-buy option. In some embodiments, a merchant can advertise items for sale online, via a website, for example. A shopper can order a number of items from the merchant and physically receive them for a trial period without being charged. During the trial period, the merchant may periodically query the shopper as to whether or not he/she wishes to keep or return the one or more of the items. The merchant can evaluate the responses to the inquiries and take appropriate action. For example, if the shopper decides to return one or more of the items, the shopper may never be charged for those items. However, if the shopper decides to keep any of the items, the merchant may charge the shopper's credit card appropriately.

### BRIEF DESCRIPTION OF THE DRAWINGS

For a better understanding of the aforementioned embodiments of the invention as well as additional embodiments thereof, reference should be made to the Detailed Description below, in conjunction with the following drawings, in which like reference numerals refer to corresponding parts throughout the figures.

FIG. 1 depicts a system for online shopping with try-before-you-buy, in accordance with various embodiments.

FIGS. 2-7 are flow diagrams illustrating processes for online shopping with try-before-you-buy options, in accordance with various embodiments.

### DETAILED DESCRIPTION

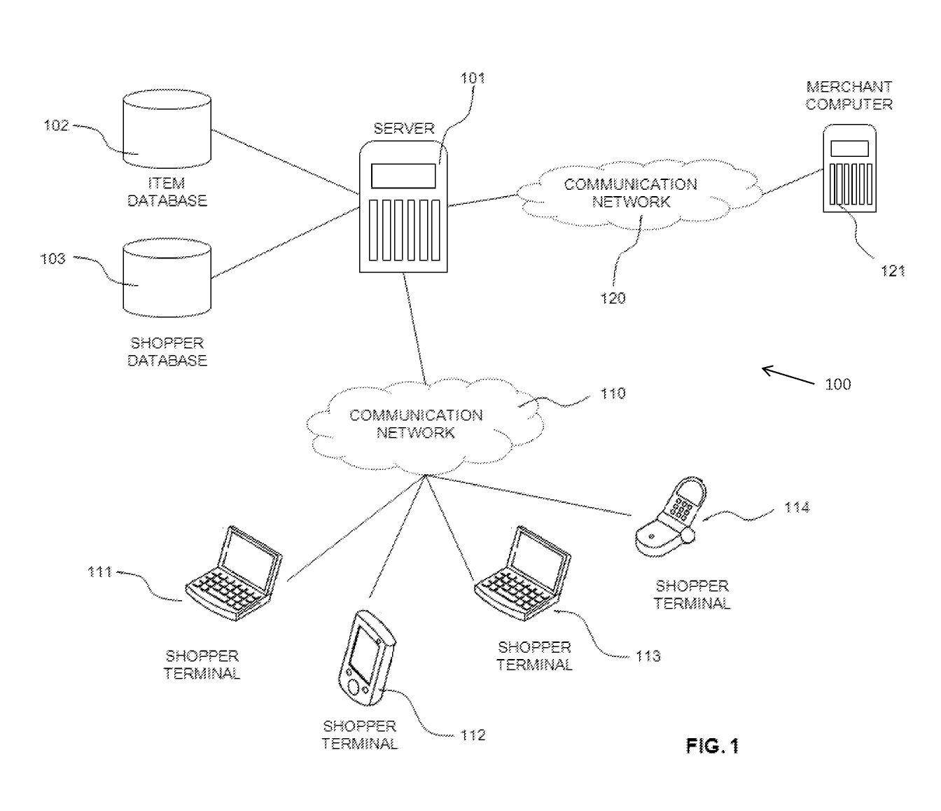

Referring to FIG. 1, a system 100 for online shopping with try-before-you-buy options in accordance with various embodiments is shown. System 100 can include a server 101 that may be communicatively coupled to shopper terminals 111, 112, 113, and 114 via a first communication network 110. Examples of shopper terminals 111-114 may include, for example, computers, laptops, mobile communication devices, PDAs, and/or any other suitable electronic devices. First communication network 110 may be an Internet communication network, mobile telecommunication network, or any other suitable network.

Server 101 can include an item database 102 storing information regarding items to be sold. For example, server 101 can store an individual data entry for each item in a merchant's inventory. Alternatively, each data entry can represent a particular good (e.g., a shirt) along with the quantity of that good in the merchant's inventory.

Server 101 can provide an interface to shopper terminals 111, 112, 113, and 114 for accessing item database 102 in order to facilitate e-commerce transactions. For example, item database 102 may include data entries representing goods such as apparel, jewelry, and fashion accessories that are available for purchase. The shopper can use a shopper terminal (e.g., one of shopper terminals 111, 112, 113, and 114) to log on to first communication network 110 (e.g., the Internet) and access item database 102 through a website of server 101. Server 101 may periodically update the information stored in item database 102 based on, for example, the items in stock, new arrivals, and/or popular purchases.

Server 101 may further include a shopper database 103 that can be populated with personal information about individual shoppers. This information may include personal information such as the shopper's name, billing information (e.g., credit card details), and/or delivery information (e.g., address and delivery preferences). When a shopper accesses server 101 using a shopper terminal, by signing into a password-protected account, for example, server 101 can access shopper database 103 and retrieve the shopper's personal information.

Server 101 may also be communicatively coupled to a merchant computer 121 via a second communication network 120. Merchant computer 121 can facilitate third party processing of payment (e.g., credit card payments) during transactions. According to some embodiments, second communication network 120 may be the same network as first communication network 110.

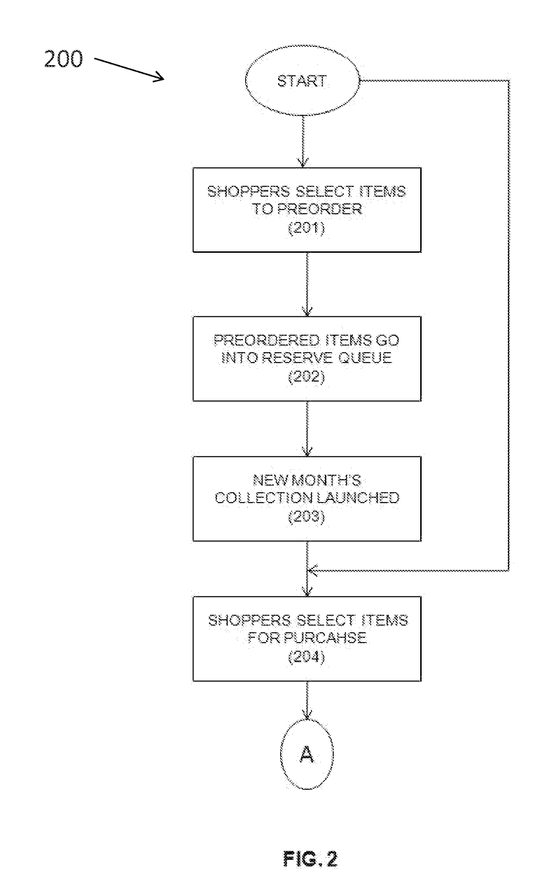

FIG. 2 is a flow diagram illustrating a process 200 for online shopping with try-before-you-buy options in accordance with various embodiments using a shopper terminal (e.g., one of shopper terminals 111-114 of FIG. 1). At step 201, a shopper can select items to preorder. For example, a server (e.g., server 101 of

FIG. 1) can select a number of items from a database (e.g., item database 102 of FIG. 1) as the next month's collection. The next month's collection can be made available to shoppers on a predetermined date (e.g., the first day of the following month), and the server can allow shoppers to preorder items from the next month's collection.

At step 202, preordered items may be put into a reserve queue, which may be stored on the server. Thus, the preordered items can be reserved and kept available in stock should the shopper decide to purchase them. According to some embodiments, preordering may be allowed for some predetermined number of days in advance of the premiere of the next month's collection, and/or the maximum number of items preordered by a shopper may be regulated. As one particular example, the server may select a thirty-piece collection of “in-trend” women's accessories as the next month's collection and may allow each shopper to preorder a maximum of four items from the thirty-piece collection ten days in advance of the premiere of the collection.

At step 203, the new month's collection may be launched. For example, the new month's collection may be released on the merchant's website for access by one or more shopper terminals (e.g., shopper terminals 111, 112, 113, and 114).

After the new month's collection is launched, a shopper can select items for purchase at step 204. Shoppers selecting items for purchase at step 204 may or may not have preordered items before the new month's collection was launched. For those shoppers who preordered items, those items may be guaranteed to be in stock and ready for shipment. On the other hand, orders for items that have not been preordered may be fulfilled on a first-come first-served basis or any other suitable basis (e.g., based on whether the shopper has one or more rewards and/or credit accounts with the merchant). After a shopper has selected items for purchase, the shopper can order the items. For example, while browsing through the database, the shopper can add items to a shopping cart provided on the server's website. The shopper may modify the shopping cart and add or delete items in the cart. Once the contents of the cart are finalized, the shopper can place the order on the items in the cart.

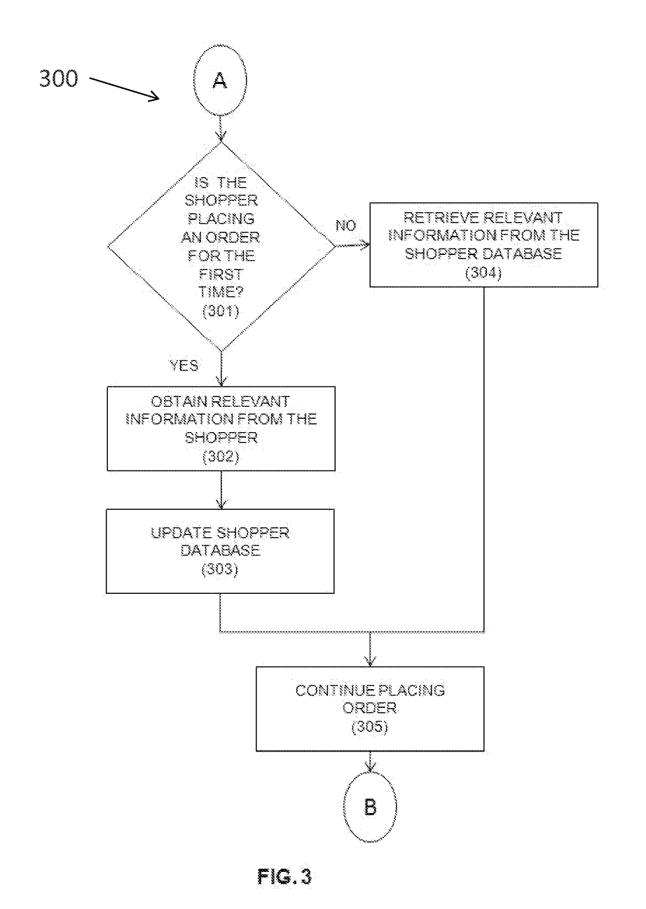

FIG. 3 is a flow diagram illustrating a process 300 for online shopping with try-before-you-buy options in accordance with various embodiments. In some embodiments, process 300 can be a continuation of process 200 of FIG. 2. At step 301, a server (e.g., server 101 of FIG. 1) can determine whether a shopper is placing an order for the first time. That is, the server may determine whether or not the shopper had previously been involved in any transaction with the merchant.

If the shopper is placing an order for the first time, process 300 may proceed to step 302 in which the shopper is prompted to submit relevant information. The relevant information may include, for example, the shopper's billing information (e.g., credit card information) and delivery information (e.g., address and/or shipping preferences). The relevant information may further include information regarding shopping preferences of the shopper or any other such pertinent information. The server can then populate a shopper database (e.g., shopper database 103 of FIG. 1) with the relevant information received from the shopper at step 303.

If the server determines that shopper had previously placed an order, the server can retrieve the relevant information from the shopper database at step 304, which may have been submitted by the shopper while placing the previous order. This process eliminates the need to input relevant information every time the shopper is placing an order.

At step 305, the server can then use the relevant information entered at step 302 or retrieved at step 304 to continue placing the order. For example, the relevant information may be preloaded into one or more order forms. According to some embodiments, the server may also allow shoppers to update or modify the previously submitted relevant information. For example, the shopper may wish to update the address and/or payment method on file in the shopper database.

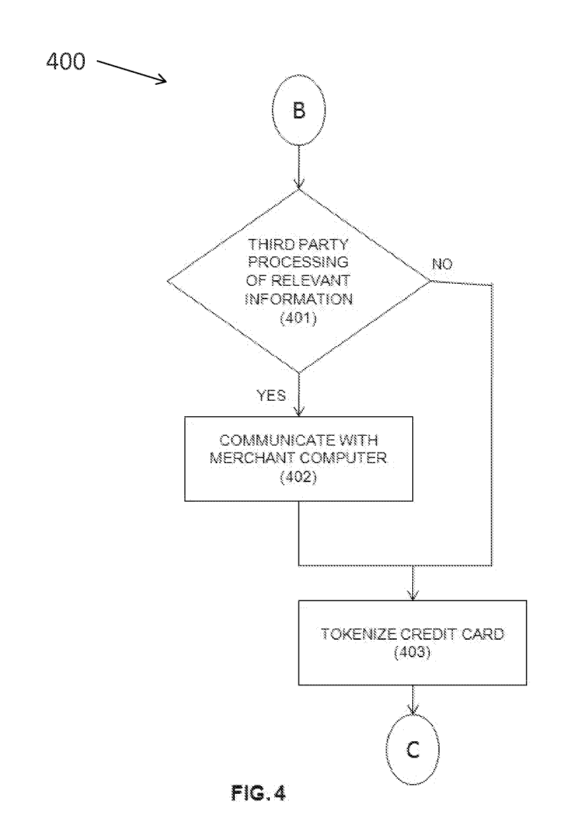

FIG. 4 is a flow diagram illustrating a process 400 for online shopping with try-before-you-buy options in accordance with various embodiments. In some embodiments, process 400 may be a continuation of process 200 of FIG. 2 and/or process 300 of FIG. 3. At step 401, a server (e.g., server 101 of FIG. 1) can determine whether to allow third party processing of relevant shopper information (e.g., credit card information).

If the server determines that a third party should process the relevant information, process 400 may proceed to step 403 in which a third party merchant computer (e.g., merchant computer 121 of FIG. 1) can process the relevant information. One example of such a third-party merchant computer is Authorize.net. On the other hand, if the server determines that a third party should not process the relevant information, the server can undertake processing of the relevant information, and process 400 can proceed directly to step 403.

The server can tokenize the shopper's credit card at step 403. Through this tokenizing process, the credit card of the shopper may not be immediately charged with the billing amount, but instead the server may retain the right to charge the credit card at a later time.

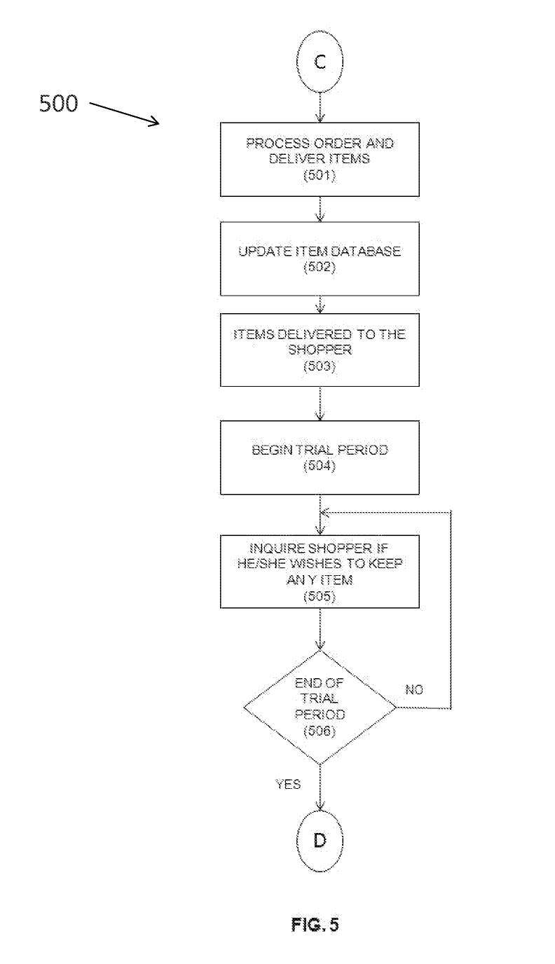

FIG. 5 is a flow diagram illustrating a process 500 for online shopping with try-before-you-buy options, in accordance with various embodiments. In some embodiments, process 500 may be a continuation of process 200 of FIG. 2, process 300 of FIG. 3, and/or process 400 of FIG. 4. As shown in FIG. 5 at step 501, a server (e.g., server 101 of FIG. 1) can process a shopper's order and arrange to deliver items to the shopper. For this purpose, the server can use delivery information submitted by the shopper or retrieved from a shopper database (e.g., shopper database 103 of FIG. 1).

At step 502, after processing the order, the server can update a database (e.g., item database 102 of FIG. 1) to reflect the current transaction. In some embodiments, the server may further keep track of the delivery of the items and register the date and time when the items are successfully delivered to the shopper. The items can be delivered to the shopper at step 503. The items may be physically delivered to the user along with a self-addressed stamped envelope/box for returning the one or more items back to the original sender or a new entity. Items ordered together may be shipped together or individually.

At step 504, the server can commence a trial period in which the shopper can try or otherwise evaluate the delivered items. For example, the shopper may be permitted to try on apparel or jewelry during the trial period. The trial period may be of a suitable duration to allow the shopper to evaluate the item and choose whether or not to keep it permanently. For example, for an article of clothing, a trial period of one week measured from the date of delivery at the shopper's address might be appropriate. One skilled in the art will appreciate that the trial period may be of any suitable duration.

At step 505, the server can automatically query the shopper as to whether he or she wishes to keep any or all of the delivered items. This inquiry may be made through e-mail, a short message service (“SMS”), an interactive voice response service (“IVRS”), live telephone, or any other suitable mode of communication. According to some embodiments, the server may allow shoppers to choose their preferred mode of communication for the purpose of inquiry. Such queries may begin at any suitable time after the shopper receives the delivered items and can continue at any suitable frequency. In one example, the server can query the shopper once a day beginning two days after commencement of the trial period.

At step 506, the server can determine whether the trial period has ended. If the server determines that the end of the trial period has not been reached, process 500 can return to step 505. In this manner, the server can periodically query the shopper during the trial period.

If the server determines that the trial period has ended, the server may initiate one or more additional actions. For example, in the case that server did not receive a response to an inquiry during the trial period, the server may determine that the shopper wishes to keep the delivered items. At the end of the trial period, the server may communicate that determination to the shopper. The server may also make a final inquiry at the end of the trial period that includes a date after which responses from the shopper may be ignored. For instance, if the shopper fails to respond within two weeks of a final inquiry, the server can charge the shopper for the delivered items.

The server may also present to the shopper a list of the choices the shopper had made during previous inquiries corresponding to the order. The list may be, for example, an accounting of which items the shopper has chosen to keep and which items the shopper has chosen to return. At this point, the shopper may be given the opportunity to amend the list. Before shipping back unwanted items and being charged for items the shopper has chosen to keep.

According to some embodiments, each of the delivered items may have its own particular trial period. For example, the trial period for a particular article of clothing might be four days, while the trial period for a particular piece of jewelry might be two days.

As one particular example of the above-described method, after the delivery of one or more items, the shopper can be given four days to try the items. On each of these four days, the shopper may receive an e-mail from the server querying whether he/she wishes to keep any item. The email may contain, for example, an image, price, and/or description of each of the items. For each of the items, the email can include two option buttons for the shopper to choose (e.g., ‘KEEP’ or ‘RETURN’). Based on his/her liking, the shopper can choose to keep or return the items. If the shopper clicks the ‘KEEP’ button for an item, then that item may not show up in subsequent email inquiries. However, the items that the shopper had chosen to return may continue to appear in subsequent email inquiries. On the last day of the trial period, the server can notify the shopper that the trial period has ended.

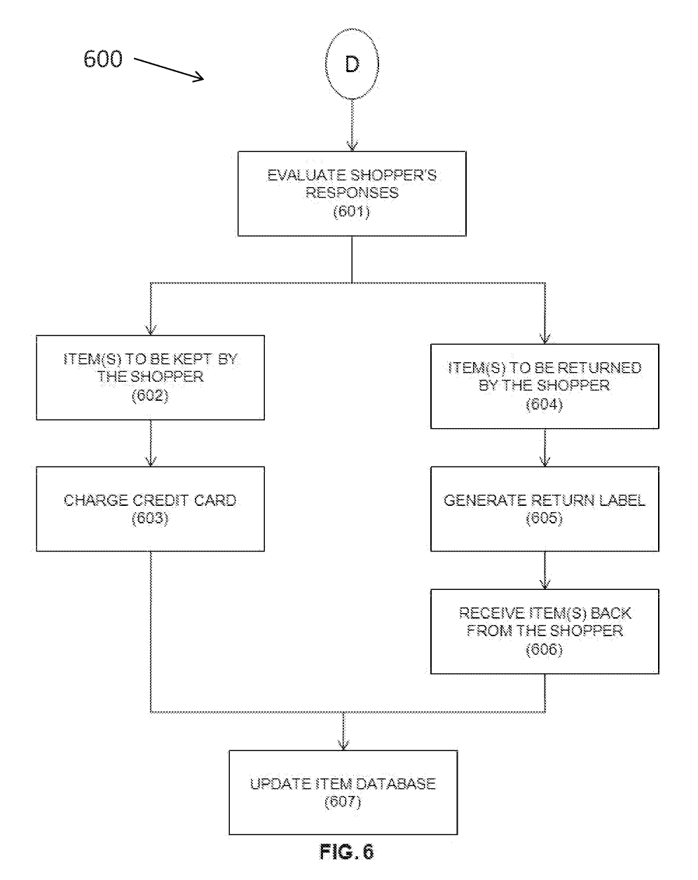

FIG. 6 is a flow diagram illustrating a process 600 for online shopping with try-before-you-buy options in accordance with various embodiments. In some embodiments, process 600 may be a continuation of process 200 of FIG. 2, process 300 of FIG. 3, process 400 of FIG. 4, and/or process 500 of FIG. 5. After the end of a trial period (e.g., the end of a trial period has been reached in step 506 of FIG. 5), a server (e.g., server 101 of FIG. 1) can evaluate a shopper's responses submitted in response to inquiries (e.g., queries at step 505 of FIG. 5) and can determine whether the shopper has opted to return any or all of the items at step 601.

After evaluation of the shopper's responses at step 601, process 600 can proceed to step 602 to process any items to be kept by the shopper. For example, if the shopper indicated his/her desire to keep one or more items based on a response (or lack of response) to one or more inquiries from the server, those items may be processed at step 602. Subsequently, at step 603, the server can automatically charge the shopper's credit card with the amount corresponding to the items that the shopper opted to keep.

Process 600 may also proceed to step 604 to process any items to be returned by the shopper. For example, based on a response to one or more inquiries from the server, the server can notify the shopper that he/she has chosen to return one or more items and facilitate the return of the one or more items.

Optionally, at step 605, the server can generate a return label for the shopper. The server may also provide the shopper with return instructions and additional shipping information. For example, in case the shopper had opted to return any item(s), the server can generate a return label containing return instructions and shipping details and send it to the shopper (e.g., by mail, e-mail, or any other suitable method). The shopper can affix the return label to the same box or boxes in which he/she received the items or to any other suitable package. At step 606, the items may be received back from the shopper.

For all items, whether they were kept or returned, the server can update the item database at step 607. For example, the server may remove any items kept by the shopper from their inventory. Correspondingly, the server may refresh the availability of returned items such that they may be ordered by other shoppers. For example, if a returned item had been preordered, it can be removed from a reserve queue.

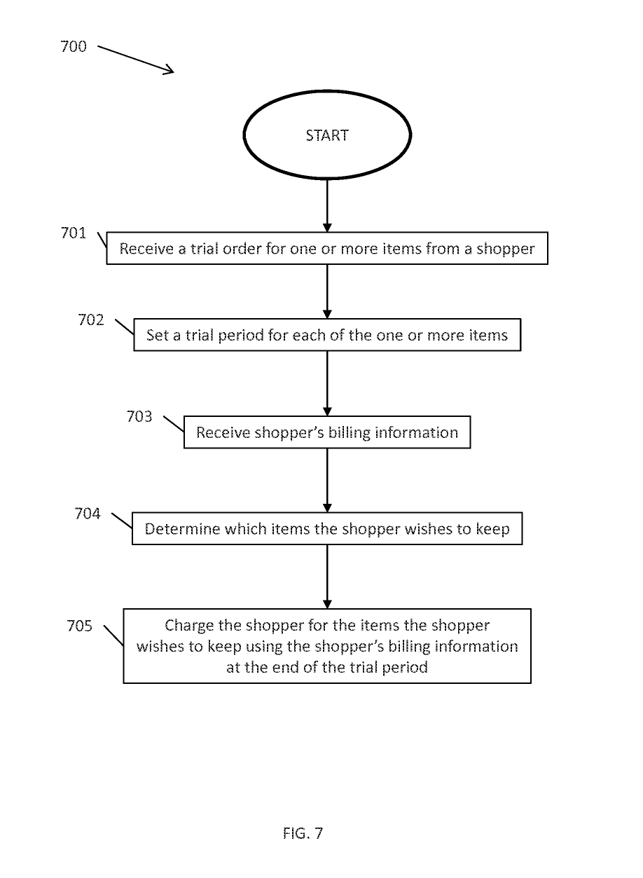

FIG. 7 is a flow diagram illustrating a process 700 for online shopping with try-before-you-buy options in accordance with various embodiments. At step 701, a merchant's server (e.g., server 101 of FIG. 1) can receive a trial order for one or more items from a shopper using a shopper terminal (e.g., one of shopper terminals 111-114 of FIG. 1). The items may be advertised on the merchant's website hosted on the merchant's server, for example.

At step 702, the merchant's server can set a trial period for each of the one or more items. Accordingly, in some embodiments each item ordered by the shopper can have a separate trial period. However, it should be noted that the same trial period may be set for all items ordered by the shopper. The trial period may depend on the type of item or items ordered by the shopper. For example, the trial period for an article of clothing may be longer than the trial period for a piece of jewelry. The trial period may also be dependent on any other suitable factor such as, for example, whether the shopper is a member of the merchant's rewards program, has a credit card or other account associated with the merchant, has a history of returning unwanted items within the trial period, and/or pays a premium for a longer trial period.

At step 703, the merchant's server can receive the shopper's billing information. The billing information can be any data that enables the merchant to charge the shopper. For instance, the billing information may be the shopper's credit card information, checking account number, online payment account information (e.g., PayPal™), or any other suitable billing information. At this step, the merchant's server can collect the shopper's billing information and reserve the right to charge the shopper at the end of the trial period and/or upon notification that the shopper wishes to keep one or more of the items.

At step 704, the merchant's server can determine which items the shopper wishes to keep, if any. According to some embodiments, the server can make this determination by querying the shopper one or more times during the trial period. In response to receiving one or more responses to the queries (e.g., an indication of whether the shopper wishes to keep or return any or all of the items), the server can compile a list of the items the shopper wishes to keep.

According to some embodiments, the server can wait a predetermined duration after the expiry of the trial period and then charge the shopper for any items the shopper has not returned to the merchant. The predetermined duration may last any suitable length of time and may be dependent on one or more of the factors described above with respect to determining the length of the trial period. In one particular example, the shopper may be charged for an item if it is not returned to the merchant within two weeks of the end of the trial period.

At step 705, the merchant's server can charge the shopper for the items the shopper wishes to keep using the shopper's billing information at the end of the trial period. That is, once the server has determined which items the shopper wishes to keep (e.g., based on response to one or more queries or because the shopper did not return the items within a predetermined duration following the expiry of the trial period) the merchant's server can arrange to charge the shopper for the non-returned items. The merchant may choose to charge the shopper directly via the merchant's server or indirectly with the assistance of a third party merchant computer.

It is to be understood that the steps shown in processes 200, 300, 400, 500, 600, and 700 are merely illustrative and that existing steps may be modified or omitted, additional steps may be added, and the order of certain steps may be altered.

Moreover, the methods described with respect to FIGS. 2-7, as well as any other aspects of the invention, may each be implemented by software, but may also be at least partially implemented in hardware, firmware, or any combination of software, hardware, and firmware. They each may also be at least partially embodied as machine-readable code recorded on a machine-readable medium. The machine-readable medium may be any data storage device that can store data that can thereafter be read by a computer system. Examples of the machine-readable medium may include, but are not limited to, read-only memory, random-access memory, flash memory, CD-ROMs, DVDs, magnetic tape, and optical data storage devices. The machine-readable medium can also be distributed over network-coupled computer systems so that the machine-readable code may be stored and executed in distributed fashion.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for selling goods online, comprising:
receiving, at a server of a merchant, a trial order for at least one item from a shopper using a shopper terminal;
setting a trial period for each of the at least one item using the server;
receiving a shopper's billing information;
determining which items of the at least one item the shopper wishes to keep; and
charging the shopper for the determined items using the shopper's billing information after the trial period ends.

2. The method of claim 1, wherein the trial period is the same for each of the at least one item.

3. The method of claim 1, wherein a duration of the trial period differs for at least two subsets of the at least one item.

4. The method of claim 1, further comprising:
querying the shopper at least once during the trial period to determine which of the at least one item the shopper wishes to keep.

5. The method of claim 4, wherein determining further comprises:
receiving a response to the querying at the server.

6. The method of claim 1, further comprising:
setting a predetermined duration after an expiry of the trial period.

7. The method of claim 6, wherein determining further comprises:
determining which items have not been returned to the merchant at an end of the predetermined duration.

8. An online shopping system, comprising:
a server of a merchant communicatively coupled to a communication network; and
an item database communicatively coupled to the server, the item database comprising a plurality of data entries, each data entry representing an item available for purchase, wherein the server is configured to:
receive a trial order from a shopper utilizing a shopper terminal for at least one item;
receive billing information from the shopper;
set a trial period for the at least one item; and
charge the shopper only for items the shopper chooses to keep after the trial period has ended.

9. The online shopping system of claim 8, further comprising:
a shopper database comprising a plurality of shopper entries, each shopper entry in the shopper database representing an individual shopper and comprising at least one of the billing information and a shipping address of the individual shopper.

10. The online system of claim 8, further comprising:
a merchant computer configured to process the billing information of the shopper.

11. The online system of claim 8, the server being further configured to:
set a predetermined duration after the trial period ends; and
charge the shopper for items still in the shopper's possession after the predetermined duration elapses.

12. The online system of claim 8, the server being further configured to:
query the shopper via the shopper terminal to determine whether the shopper wishes to keep or return each of the items; and
charge the shopper only for items the shopper wishes to keep.

13. The online system of claim 8, wherein a duration of the trial period depends on at least one of whether the shopper:
is a member of a rewards program;
has a credit card or other account associated with the merchant;
has a history of returning unwanted items within the trial period; and
pays a premium for a longer trial period.

14. A non-transitory computer-readable medium for e-commerce, comprising computer-readable instructions recorded thereon for:
receiving an order for at least one item offered by a merchant that was selected by a shopper;
receiving the shopper's payment information;
querying at least one time during a trial period associated with the at least one item to determine whether any of the items of the at least one item will be purchased;
evaluating any responses received during querying; and
charging the shopper for the items that will be purchased only after expiration of a trial period, wherein charging comprises using the shopper's received payment information.

15. The non-transitory computer-readable medium of claim 14, further comprising:
computer-readable instructions recorded thereon for determining a duration of the trial period.

16. The non-transitory computer-readable medium of claim 14, wherein a duration of the trial period is determined based on at least one of whether the shopper:
is a member of a rewards program for the merchant;
has a credit card or other account associated with the merchant;
has a history of returning unwanted items within the trial period; and
pays a premium for a longer trial period.

17. The non-transitory computer-readable medium of claim 14, further comprising computer-readable instructions recorded thereon for:
setting a predetermined duration after the trial period has ended; and
charging the shopper for items still in the shopper's possession after the predetermined duration has elapsed.

18. The non-transitory computer-readable medium of claim 14, further comprising computer-readable instructions recorded thereon for:
querying at least one time during the trial period to determine which items of the at least one item will be purchased.

19. The non-transitory computer-readable medium of claim 18, further comprising computer-readable instructions recorded thereon for:
preparing an accounting of the items the shopper wishes to keep and items the shopper wishes to return.

20. The non-transitory computer-readable medium of claim 14, further comprising computer-readable instructions recorded thereon for:
setting the trial period differently for at least two subsets of the at least one item.
